(19) United States
(12) Patent Application Publication
(10) Pub. No.: US 2008/0031670 A1
(43) Pub. Date: Feb. 7, 2008

(54) IMAGE FORMING APPARATUS

(75) Inventors: Jong-woo KIM, Yongin-si (KR); Douk-soon Cha, Seongnam-si (KR); Jin-young Jeon, Suwon-si (KR); Sang-pil Yoon, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/765,030

(22) Filed: Jun. 19, 2007

(30) Foreign Application Priority Data
Aug. 1, 2006 (KR) 2006-72677

(51) Int. Cl. G03G 15/00

(52) U.S. Cl. 399/405; 399/313

(57) ABSTRACT

An image forming apparatus, including a storing part in which a print medium is stored, an image forming part to form an image on the print medium, a discharging part to discharge the print medium to an exterior of the apparatus, and an electrostatic belt to attract the print medium via static electricity, and to transfer the attracted print medium.

### CROSS-REFERENCE TO RELATED APPLICATION

This application claims the benefit of Korean Application No. 2006-72677, filed Aug. 1, 2006 in the Korean Intellectual Property Office, the disclosure of which is incorporated herein by reference.

### BACKGROUND OF THE INVENTION

1. Field of the Invention

An aspect of the present invention relates to an image forming apparatus, and, more particularly, to an image forming apparatus having an improved print medium transferring configuration.

2. Description of the Related Art

In general, an image forming apparatus is coupled to a host apparatus to print image data generated or stored in the host apparatus onto a print medium according to an output signal applied from the host apparatus. Such an image forming apparatus comprises a photosensitive body on which an electrostatic latent image is formed, a developing roller to selectively develop developer on the photosensitive body, and a transferring device to transfer the developer developed on the photosensitive body onto the print medium to print a desired image during an electro-photographic operation. An electro-photographic image forming apparatus comprises a printer, a photocopier, and a multi-functional device, or the like.

FIG. 1 is a sectional view illustrating a configuration of a conventional electro-photographic image forming apparatus 80. As shown in FIG. 1, the electro-photographic image forming apparatus 80 comprises a print medium storing part 10 in which print media are stored, an image forming part 40 to form an image on the print medium which is fed from the print medium storing part 10, a fixing part 50 to fix the developer spread onto a surface of the print medium by an application of heat and pressure, a discharging part 60 to discharge the print medium to an exterior of the image forming apparatus, and a main body frame 70 accommodating these components.

An image forming process of the image forming apparatus 80 with the above-described configuration will be described by referring to FIG. 1. First, the print medium stored in the print medium storing part 10 is fed by a pick-up roller 11. Then, plural numbers of transfer rollers 13 and 14 guide the print medium to the image forming part 40. The image forming part 40 forms an image on the print medium, and the image-formed print medium is discharged to the exterior by discharging rollers 61 and 63.

However, in the conventional image forming apparatus 80 noise is created when the print medium is transferred along a transferring path in the image forming apparatus 80. FIG. 3 illustrates sonic data reflecting the noise caused when the print medium undergoes an image forming process of the image forming apparatus 80 according to time. As shown in FIG. 2, the print medium transferring path is divided into plural numbers of areas and noise generated in the respective areas will be described with the data in FIG. 3.

A first noise ‘A’ is generated, as shown in FIG. 3, by a driving part (not shown) to drive the respective components of the image forming apparatus 1 before the print medium is fed. The noise of the driving part is generated by the driving of a motor, a gear, and so on. A second noise ‘B,’ measured as a high decibel noise, is generated by a solenoid (not shown) that causes a knock-up plate 10a to ascend. A third noise ‘C’ is generated by friction between the surface of the pick-up roller 11 and a leading edge of the print medium when the print medium is picked up by the pick-up roller 11. A fourth noise ‘D’ is generated by friction between the trailing edge of the print medium and the pick-up roller 11 (see section “a” in FIG. 2). A fifth noise ‘E’ is generated when the leading edge of the print medium, transferred from the pick-up roller 11, reaches a transfer roller 14. A sixth noise ‘F’ is generated while the trailing edge of the print medium passes through the transfer roller 14 and when the leading edge of the print medium enters the image forming part 20 to form an image (see sections “b”, “c and “d” in FIG. 2). A seventh noise ‘G’ is generated when the trailing edge of the print medium, on which the image is formed in the image forming part 20, passes through an alignment roller 61 (see section “e” in FIG. 2). An eighth noise ‘H’ is generated by a vibration of the print medium generated when the trailing edge of the print medium is discharged and touches the discharging roller 63 (see section “f” in FIG. 2). Furthermore, the noise ‘I’ is generated by a vibration generated when the print medium is discharged and the trailing edge of the print medium touches the discharging part 60 (see section “g” in FIG. 2).

As is described above, in the image forming apparatus 80, noises are continuously generated during the image forming process, and, as shown in FIG. 2, certain noises may exceed 50 decibels. The noises may cause inconveniences for a user.

### SUMMARY OF THE INVENTION

It is therefore an aspect of the invention to provide an image forming apparatus which minimizes noise generated during an image forming process.

The foregoing and/or other aspects of the present invention may be achieved by providing an image forming apparatus, including a storing part in which a print medium is stored, an image forming part to form an image on the print medium, a discharging part to discharge the print medium to an exterior of the apparatus, and an electrostatic belt to attract the print medium via static electricity, and to transfer the attracted print medium.

According to the embodiment of the present invention, the image forming apparatus further comprises a voltage supply part to supply a voltage generating a static electricity to at least one of the electrostatic belt and the rollers.

According to the embodiment of the present invention, the rollers comprises a driving roller driven by a predetermined driving part, and a plurality of idle rollers which rotate according to the driving of the driving roller and guide the electrostatic belt.

According to the embodiment of the present invention, the main body frame comprises an adsorption member to maintain the print medium transferred by the electrostatic belt in an attracted state with respect to the surface of the electrostatic belt.

According to the embodiment of the present invention, the adsorption member is in an area where a curvature changes among the print medium transferring paths.

According to the embodiment of the present invention, the adsorption member is within a range of 1 mm to 1.5 mm from the electrostatic belt.

According to the embodiment of the present invention, the image forming apparatus further comprises a discharging unit, the discharging unit comprising: a discharging electrostatic belt which is on one side of the discharging part and attracts the image-formed print medium in the image forming part by an electrostatic force and guides the attracted print medium to be discharged to an exterior of the apparatus; and a roller to drive the discharging electrostatic belt.

According to the embodiment of the present invention, the image forming apparatus further comprises a voltage supply part to supply a voltage generating an electrostatic force to at least one of the discharging electrostatic belt and the roller.

According to the embodiment of the present invention, the roller comprises a driving roller driven by a predetermined driving part, and a plurality of idle rollers which rotate according to driving of the driving roller and guide the discharging electrostatic belt.

According to the embodiment of the present invention, the main body frame comprises an adsorption member to maintain the print medium transferred by the discharging electrostatic belt in the attracted state thereof with respect to the surface of the electrostatic belt.

The foregoing and/or other aspects of the present invention may be achieved by providing an image forming apparatus, comprising: a print medium storing part in which a print medium is stored; an image forming part to form an image on a print medium fed from the print medium storing part; a discharging part to discharge the print medium on which an image is formed in the image forming part to the outside; a main body frame supporting the print medium storing part, the image forming part, and the discharging part; a feeding unit feeding a print medium stored in the print medium storing part to the image forming part; and an adsorption member which guides the print medium to be transferred to the image forming part by the feeding unit.

According to the embodiment of the present invention, the adsorption member guides the print medium to be positioned within a range in which the electrostatic force of the feeding unit reaches in the case that the feeding unit transfers a print medium by an electrostatic force.

According to the embodiment of the present invention, the adsorption member is in an area where a curvature is changed on a print medium transferring path between the print medium storing part and the image forming part.

According to the embodiment of the present invention, the adsorption member has a curved surface corresponding to a curvature of the print medium transferring path.

According to the embodiment of the present invention, the image forming apparatus further comprises an adsorption member which guides the print medium on which an image is formed in the image forming part to be discharged to the outside.

The foregoing and/or other aspects of the present invention can be achieved by providing an image forming method for an image forming apparatus comprising a print medium storing part in which a print medium is stored, and an image forming part to form an image on a print medium fed from the print medium storing part, comprising: feeding a print medium by supplying an electrostatic force to the print medium stored in the print medium storing part; transferring the print medium to the image forming part by supplying an electrostatic force to the fed paper; forming an image on the transferred paper; and discharging the print medium to the outside by supplying an electrostatic force to the image-formed paper.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view illustrating a configuration of a conventional image forming apparatus;

FIG. 2 is a schematic view illustrating a print medium transferring path of a conventional image forming apparatus;

FIG. 3 illustrates data of noises generated during an image forming process of a conventional image forming apparatus;

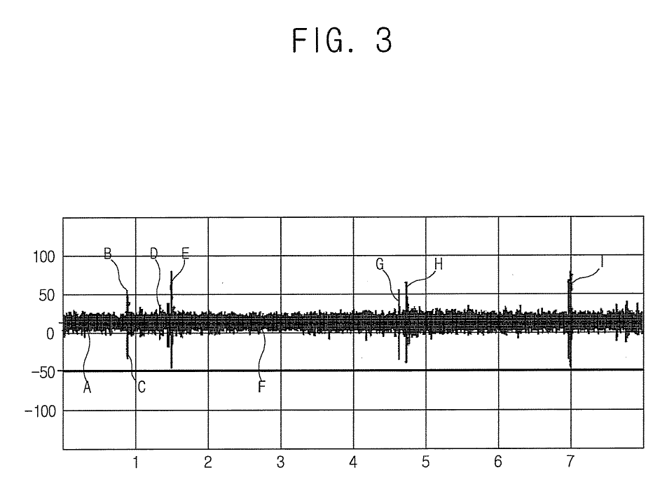

FIG. 4 is a schematic view illustrating a configuration of an image forming apparatus according to an exemplary embodiment of the present invention;

FIG. 5 is a schematic view illustrating a print medium transferring path of an image forming apparatus according to an embodiment of the present invention;

FIG. 6A is a schematic view illustrating a configuration of a feeding unit in FIG. 4; and

FIG. 6B is a schematic view illustrating a configuration of a discharging unit in FIG. 4.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

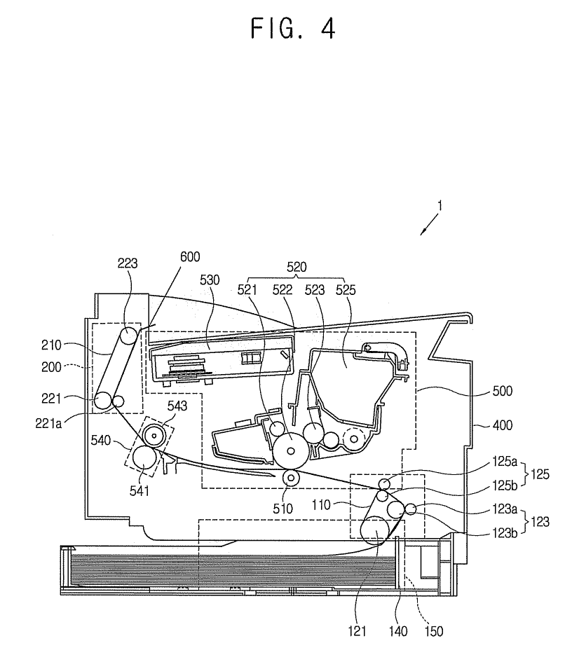

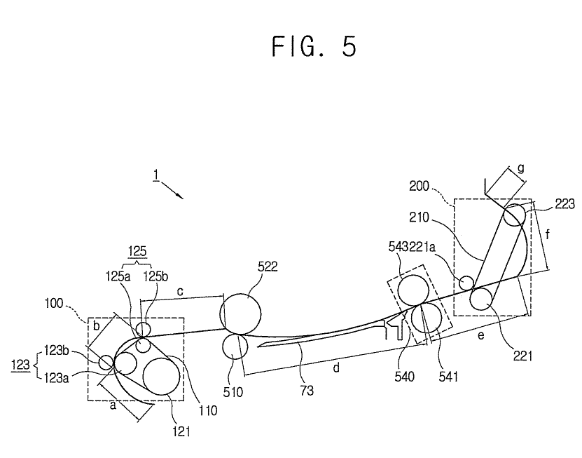

FIG. 4 is a schematic view illustrating a configuration of an image forming apparatus according to an exemplary embodiment of the present invention, and FIG. 5 is a schematic view illustrating a transferring path of an image forming apparatus 1 according to an embodiment of the present invention. According to one illustrative aspect of the invention, the image forming apparatus 1, shown in FIGS.4 and 5, comprises the print medium storing part 150 in which print media (i.e., paper, transparencies, etc.) are stored. In accordance with this aspect of the invention, a feeding unit 100 feeds the print medium from the storing part 150 to the image forming part 500, which forms an image on the print medium. A discharging unit 200 discharges the print medium to an exterior of the image forming apparatus 1. A voltage supply part 300 supplies a voltage to the feeding part 100 and the discharging part 200.

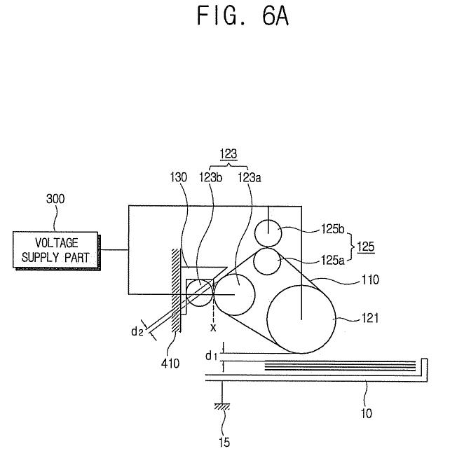

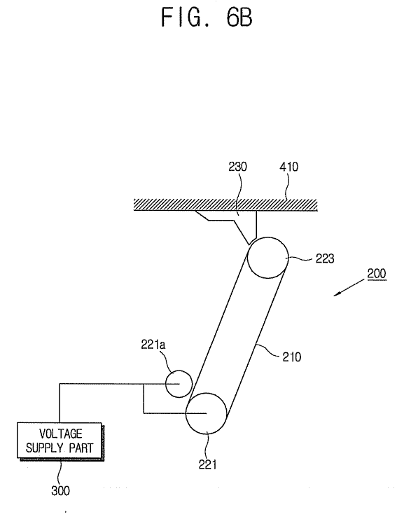

As shown in FIGS.4 and 5, the print medium storing part 150 comprises a knock-up plate 140. Here, the knock-up plate 140 is provided to be placed within a range where an electromagnetic force of the feeding part 100 is applied. For this, the printing medium storing part 150 may include an elastic member (not shown) to elastically support the knock-up plate 140. The electrostatic force is proportional to the voltage supplied in the voltage supply part 300. For example, where the voltage supplied from the voltage supply part 300 to the feeding unit 100 is 1 KV, the distance d1 between the print medium stored in the knock-up plate 140 and the feeding unit 100 may be maintained around 1 mm. Meanwhile, a grounding part 15 (refer to FIG. 6A) is provided on one side of the print medium storing part 10 to ground the print medium when the print medium, stored on an upper surface of the print medium storing part 10, is adsorbed by an electrostatic force (here, it is noted that the term “adsorb” relates to the attraction of the print medium to a charged surface that can hold and/or carry the print medium under an adsorbed state, although it is further noted that any type of attraction can be generated with respect to the print medium that allows the print medium to be carried or transported).

As shown in FIG. 6A, the feeding unit 100 comprises a feeding electrostatic belt 110 which adsorbs a print medium from the print medium storing part 10 onto a surface thereof via an electrostatic force and which guides the adsorbed print medium to the image forming part 40. A feeding driving roller 121, driven by a predetermined driving part (not shown), and feeding idle rollers 123 and 125, which are rotated by the feeding driving roller 121, drive the feeding electrostatic belt 110. An adsorption member 130, which is provided on one side of a casing 410, guides the print medium so that the print medium, having been transferred along the feeding electrostatic belt 110 maintains an adsorbed property thereof with respect to the feeding electrostatic belt 110.

The feeding electrostatic belt 110 has a predetermined width and adsorbs the print medium in the storing part 10 by the electrostatic force. The feeding electrostatic belt 110 comprises a conductive material and a surface that is electrified by being directly supplied with voltage by the voltage supply part 300 to generate static electricity. Alternately, the surface is electrified by contacting the rollers 121, 123, and 125, which may also receive the supply of the voltage. Here, according to an embodiment of the invention, the feeding electrostatic belt 110 may employ an image transfer belt used when a toner image is transferred in a conventional color image forming apparatus or a print medium transfer belt used when a print medium is transferred.

The feeding driving roller 121 rotates in connection with a predetermined driving part (not shown). The feeding driving roller 121 rotates in contact with the feeding electrostatic belt 110, and drives the feeding electrostatic belt 110. The feeding driving roller 121 is provided as a conductive material and is supplied with voltage from the voltage supply part 300 to electrify the feeding electrostatic belt 110. The feeding idle rollers 123 and 125 are provided to be in contact with the feeding electrostatic belt 110 and rotate with the feeding electrostatic belt 110 as a result of the driving of the feeding driving roller 121. The feeding idle rollers 123 and 125 comprise conductive materials. The feeding idle rollers 123 and 125 are supplied with voltage from the voltage supply part 300 and rotate in contact with the feeding electrostatic belt 110 to generate a static electricity on the surface of the feeding electrostatic belt 110.

The feeding idle rollers 123 and 125 are provided across the feeding electrostatic belt 110, and as plural numbers of rollers along the print medium transferring path. Such an arrangement maintains the electrostatic force generated on the surface of the feeding electrostatic belt 110 by continuously electrifying the feeding electrostatic belt 110. Accordingly, the print medium, having been adsorbed onto the surface of the feeding electrostatic belt 110 is transferred stably.

The respective feeding idle rollers 123 and 125 may have shapes that correspond to the characteristic shape of the feeding transferring path for particular image forming apparatuses. The respective diameters of the feeding idle rollers 123 and 125 are designed so that the curved shape of the feeding electrostatic belt 110 corresponds to the shape of the transferring path. Also, where a curvature of the transferring path from the print medium storing part 150 to the image forming part 500 is suddenly changed, plural numbers of feeding idle rollers 123 and 125 may be provided to provide the smooth curvature of the feeding electrostatic belt 110 so as to provide for a stable transfer of the print medium.

As shown in FIG. 6A, the adsorption member 130 is provided on one side of the casing 410 close to the path where the print medium, having been adsorbed onto the feeding electrostatic belt 110 from the print medium storing part 150, is transferred to the image forming part 500. In general, the print medium, having a predetermined thickness, has a rectilinear property toward a tangential direction of the curvature when the print medium passes through the position where there is a curvature. That is, where the print medium is transferred along the feeding electrostatic belt 110 and passes through the feeding idle roller 123, the print medium tends to proceed toward the tangential direction (a direction ‘x’ in FIG. 6A) of the feeding idle roller 123 as shown in the dotted line. At this time, the electrostatic force the feeding electrostatic belt 110 applies to the print medium decreases and the print medium is to be separated from the surface of the feeding electrostatic belt 110.

The adsorption member 130 is provided in a tangential direction with respect to a location where the print medium tends to separate from the transferring path. The adsorption member 130 guides the print medium so that the front edge of the print medium, having been separated from the feeding electrostatic belt 110, is adsorbed again onto the surface of the feeding electrostatic belt 110. In particular, the adsorption member 130 is provided within a predetermined range of distances from the feeding electrostatic belt 110 so as to narrow a vibrating space of the leading edge of the print medium. Accordingly, noises generated by the vibration of the print medium when the leading edge of the print medium passes through the transfer roller 123 are reduced. In particular, the distance d2 between the absorption member 230 and the feeding electrostatic belt 110 is provided in consideration of the thickness of the print medium.

For example, where a print medium having a thickness of 0.2 mm is used the distance between the adsorption member 130 and the feeding electrostatic belt 110 may be provided within the range of 1.5 to 2 mm. Here, in the case that the distance between the adsorption member 130 and the feeding electrostatic belt 110 is provided as if the distance were less than 1.5 mm, a smooth transfer of the print medium may not be reliably maintained. Also, if the distance between the adsorption member 130 and the feeding electrostatic belt 110 were over 2 mm, noises may be generated by vibration of the print medium or the print medium may be separated from the feeding electrostatic belt 110.

The adsorption member 130 may be provided where a curvature of the transferring path is changed, and, in the case that the curvature is changed in plural positions, the adsorption member 130 may be provided as a plurality of adsorption members.

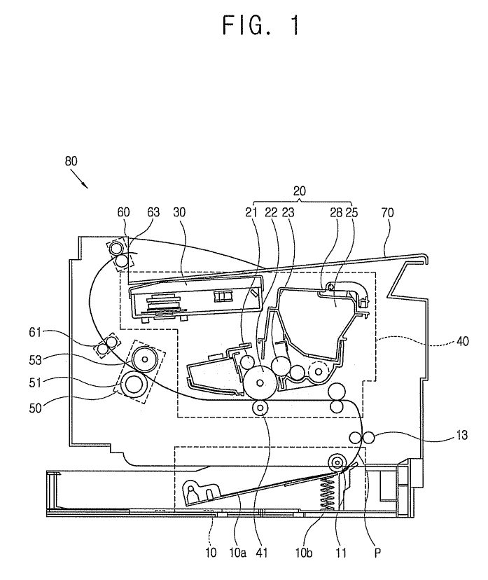

Meanwhile, the adsorption member 130 stably transfers the print medium when the print medium is not transferred by an electrostatic force of the feeding unit 100. That is, when the print medium is transferred by plural numbers of transfer rollers, as in the conventional image forming apparatus shown in FIG. 1, the adsorption member 130 may be used. In this case, the adsorption member 130 is provided within a predetermined range of positions with respective transfer rollers 123 and 125 to guide the print medium as the print medium passes through a space between the transfer rollers 123 and 125. Also, in this case, the adsorption member 230 is provided where a curvature of the transferring path is changed, and guides the print medium to thereby prevent a print medium jam from being caused when the print medium bumps against a wall surface of the casing 410.

A static electricity removing member (not shown) removes static electricity from the surface of the feeding electrostatic belt 110. The static electricity removing member contacts the feeding electrostatic belt 110 or at least one of the transfer rollers 123 and 125.

The image forming part 500 selectively spreads developer onto the print medium to form an image thereon. As shown in FIG. 4, the image forming part 500 comprises a photosensitive body 522, a laser scanning unit (LSU) 530 forming an electrostatic latent image on the surface of the photosensitive body 522, a developing roller 523 spreading developer on the electrostatic latent image of the photosensitive body 522, a developer storing part 525 in which developer is stored, and a transfer roller 510 provided to face the photosensitive body 522 across the print medium to transfer the developer onto the surface of the print medium. The fixing part 540 comprises a pressing roller 541 to apply pressure to the print medium on which an image is formed in the image forming part 500, and a heating roller 543 to apply heat to the print medium. A further description of the configurations of the image forming part 500 and the fixing part 540 of the image forming apparatus 1 of the present invention will be omitted as these elements are structured and operate similarly as in the conventional configuration.

The print medium, which enters the image forming part 500 through the feeding unit 100, is moved along a guide frame 410 and an image is formed thereon. In general, the guide frame 410 may be provided to be horizontal to stably form the image. The discharging unit 200 discharges the print medium to an exterior of the image forming apparatus 1. As shown in FIG. 6B, the discharging unit 200 comprises a discharging electrostatic belt 210 which absorbs the print medium onto its surface by an electrostatic force and transfers the print medium to outside, a discharging driving roller 221 to drive the discharging electrostatic belt 210, and an adsorption member 230 to maintain an adsorbed state of the print medium with respect to the discharging electrostatic belt 210.

The discharging driving roller 221 and discharging idle rollers 221a and 223 are respectively disposed so that the discharging electrostatic belt 210 has a shape that corresponds to the discharging path of the print medium. Here, the description of the configuration and the function of the discharging electrostatic belt 210, the discharging driving roller 221, and an adsorption member 230 will be omitted since they are substantially the same as the configuration of the feeding unit 100.

Meanwhile, the adsorption member 230 provided on one side of the discharging part 600 guides the print medium transferred to the discharging part 600 by the discharging electrostatic belt 210 to be separated from the discharging electrostatic belt 210 and transferred to the exterior. That is, the adsorption member 230 guides the print medium by its own hardness without having a separate transfer roller in the discharging part 600. At this time, the adsorption member 230 may be provided within a predetermined range of positions with respect to the discharging electrostatic belt 210 to fully guide the print medium.

The voltage supply part 300 supplies voltage so that the feeding unit 100 and the discharging unit 200 transfer the print medium by an electrostatic force. The voltage supply part 300 supplies voltage to at least one of the electrostatic belts 110 and 210 or rollers 121, 123, 125, 221, 221a, and 223 so that the electrostatic force is generated in the feeding unit 100 and the discharging unit 200. Here, a direct current or an alternating current, or both the direct current and the alternating current may be supplied for the voltage generated in the voltage supply part 300. Meanwhile, the voltage supply part 300 is separately provided to supply the voltage to the feeding unit 100 and the discharging unit 200 or integrated with a main voltage supply part (not shown) to supply the voltage to the image forming part 500. The voltage supply part 300 may supply a proper voltage in consideration of the thickness of the print medium and a distance from the knock-up plate 140.

An image forming process of the image forming apparatus 1 with this configuration according to the present invention will be described with reference to FIGS. 4 to 6B.

First, when an output signal is applied from a host apparatus, the driving part (not shown) transfers a driving force to the feeding driving roller 121. Also, the voltage supply part 300 supplies voltage to the feeding unit 100. Accordingly, the feeding driving roller 121 and the feeding idle rollers 123 and 125 are supplied with the voltage and electrify the surface of the feeding electrostatic belt 110 to generate a static electricity.

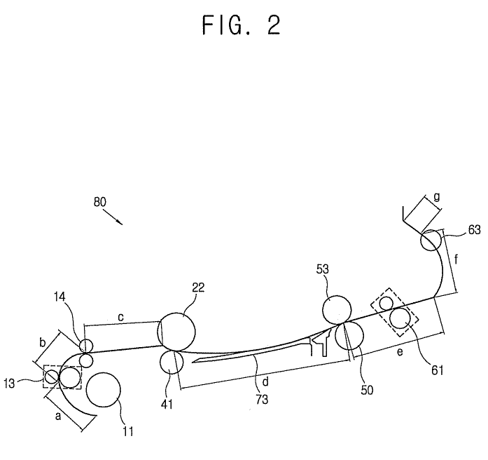

A print medium stored on top of the print medium storing part 150 is adsorbed onto the surface of the feeding electrostatic belt 110 by the electrostatic force generated from the feeding electrostatic belt 110. The feeding electrostatic belt 110 rotates with the print medium adsorbed thereto to transfer the print medium. The print medium adsorbed on the surface of the feeding electrostatic belt 110 maintains its adsorbed state while passing through the first idle roller 123, and in a curved part of the feeding electrostatic belt 110 (see area “b” of FIG. 2) by the guide of the adsorption member 130.

When the leading edge of the print medium adsorbed-transferred on the surface enters the second idle roller 125, the print medium, of which the static electricity of the feeding electrostatic belt 110 is removed by the electrostatic removing member (not shown), is separated from the feeding electrostatic belt 110 to enter between the photosensitive body 522 and the transfer roller 510. The print medium then moves along the guide frame 410, and an image is formed on the print medium. The image-formed print medium then enters the fixing part 540 where the image is fixed by an application of heat and pressure.

At this time, the voltage supply part 300 supplies a voltage to the discharging unit 200, and a static electricity is generated in the discharging electrostatic belt 210. The print medium, having passed through the fixing part 540, is adsorbed onto the surface of the discharging electrostatic belt 210 by the electrostatic force of the discharging electrostatic belt 210. The adsorbed print medium moves along the discharging electrostatic belt 210, and when the print medium passes through the discharging idle roller 223, its static electricity is removed and separated from the discharging electrostatic belt 210 to be discharged to the exterior of the image forming apparatus 1 by its own hardness according to the guide of the adsorption member 230.

As is described above, in the image forming apparatus 1 according to aspects of the present invention, since the print medium is picked up by a static electricity of the feeding unit 100, an operational noise of a conventional solenoid and a frictional noise by the pick-up roller are not generated. Since the picked-up print medium moves along the surface of the feeding electrostatic belt 110 in an absorbed state, an impulse noise due to a relative speed difference from the frame is not generated. Also, in an area where a curvature of the print medium transferring path changes, an adsorption member is provided to maintain the print medium in the adsorbed state. Further, a vibration noise generated by the vibration of a print medium may be minimized by narrowing a space in which a trailing edge of the print medium may be vibrated.

Also, when the print medium is discharged, the print medium moves with the discharging electrostatic belt 210, thereby minimizing noises generated when the print medium contacts the discharging roller. That is, in the image forming apparatus according to aspects of the present invention, noises caused by a dragging of a print medium, an impact, and/or a print medium vibration in addition to minute noises due to an operation of a driving part during the image forming process are minimized.

Meanwhile, in the above described embodiments of the present invention a monochromatic image forming apparatus has been described, but the technological concept of aspects of the present invention may also be applied to other known image forming apparatuses in which a print medium moves along a predetermined transferring path to form an image.

As is described above, the image forming apparatus according to aspects of the present invention minimizes noises generated during an image forming process.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An image forming apparatus, comprising:
a storing part in which a print medium is stored;
an image forming part to form an image on the print medium;
a discharging part to discharge the print medium to an exterior of the image forming apparatus; and
an electrostatic belt to attract the print medium via static electricity, and to transfer the attracted print medium.

2. The image forming apparatus according to claim 1, wherein the electrostatic belt is provided between the storing part and the image forming part.

3. The image forming apparatus according to claim 1, wherein the electrostatic belt is provided between the image forming part and the discharging part.

4. The image forming apparatus according to claim 1, further comprising a voltage supply part to supply a voltage generating the static electricity.

5. The image forming apparatus according to claim 1, further comprising a main body frame including an adsorption member to maintain the print medium transferred by the electrostatic belt in an attracted state with respect to a surface of the electrostatic belt.

6. The image forming apparatus according to claim 5, wherein the adsorption member is located in an area where a curvature changes along a print medium transferring path.

7. The image forming apparatus according to claim 6, wherein the adsorption member is within a range of 1 mm to 1.5 mm from the electrostatic belt.

8. The image forming apparatus according to claim 1, further comprising a discharging unit comprising:
a discharging electrostatic belt which is provided on one side of the discharging part and which attracts the image-formed print medium to guide the attracted print medium to be discharged to the exterior of the image forming apparatus; and
a roller unit to drive the discharging electrostatic belt.

9. The image forming apparatus according to claim 8, further comprising a voltage supply part to supply a voltage to generate an electrostatic force to at least one of the discharging electrostatic belt and a roller.

10. The image forming apparatus according to claim 8, wherein the roller unit comprises:
a driving roller driven by a predetermined driving part; and
a plurality of idle rollers which rotate according to driving of the driving roller and which guide the discharging electrostatic belt.

11. The image forming apparatus according to claim 8, further comprising a main body frame including an adsorption member to maintain the image-formed print medium in the attracted state thereof with respect to a surface of the electrostatic belt.

12. An apparatus to transfer a print medium through a portion of an image forming apparatus comprising:
a set of rollers, including a driving roller, disposed in positions within the apparatus corresponding to at least an original position and a destination of the print medium;
an electrostatic belt, supported by the rollers and driven by the driving roller, to attract the print medium to a surface of the electrostatic belt via static electricity and to carry the print medium in the attracted state from the original position to the destination; and
a voltage supply part to supply a voltage to at least one of the electrostatic belt and/or one or more of the rollers to generate the static electricity.

13. The apparatus according to claim 12, further comprising an adsorption member to maintain the print medium in the attracted state between the original position and the destination where the electrostatic belt curves.

14. An electro-photographic image forming apparatus including an image forming part to form an image on a print medium having been fed from a storing part, a fixing part to fix the image, and a discharging part to discharge the print medium, the apparatus comprising:
a print medium transferring path along which the print medium is transferred to the image forming part, the fixing part, and the discharging part;
rollers to guide the print medium along the transferring path; and
an adsorption member to direct a leading edge of the print medium toward the transferring path at a curve along the transferring path.

15. The apparatus according to claim 14, wherein the adsorption member is located at a position tangential to the print medium when the print medium reaches the curve of the transferring path.

16. The apparatus according to claim 14, wherein the adsorption member and the curve of the transferring path are each plural in number, and wherein each of the plural adsorption members corresponds to each of the plural curves.

17. An image forming method for use with an image forming apparatus comprising an image forming part to form an image on a print medium, the method comprising transferring the print medium to the image forming part along a transferring belt by electrostatically attracting the print medium to the transferring belt.

18. The method according to claim 17, further comprising transferring the print medium from a print medium storing part, in which print media are stacked, to the image forming part.

19. The method according to claim 17, further comprising transferring the print medium from the image forming part to a discharging part to discharge the print medium from the image forming apparatus.

20. An image forming method for use with an image forming apparatus to transfer a print medium through a portion of the image forming apparatus, the method comprising:
carrying the print medium from an original position within the image forming apparatus to a destination with the print medium attracted to a surface of an electrostatic belt via static electricity; and
supplying a voltage to the electrostatic belt to generate the static electricity.

21. The image forming method according to claim 20, wherein the original position is typified by the print medium being located at a print medium storing part and the destination is typified by the print medium being located at an image forming part.

22. The image forming method according to claim 20, wherein the original position is typified by the print medium being located at an image forming part and the destination is typified by the print medium being located at a discharging part.

23. The image forming method according to claim 20, wherein the original position is typified by the print medium being located at a print medium storing part and the destination is typified by the print medium being located at a discharging part.
